(19) United States
(12) Patent Application Publication
(10) Pub. No.: US 2014/0039656 A1
(43) Pub. Date: Feb. 6, 2014

(54) AUTOMATED PLANNING OF CONTROL EQUIPMENT OF A TECHNICAL SYSTEM

(71) Applicants: Hans-Dieter Humpert, Hemhofen (DE); Dieter Kleyer, Herzogenaurach (DE); Klaus Wendelberger, St. Leon-Rot (DE)

(72) Inventors: Hans-Dieter Humpert, Hemhofen (DE); Dieter Kleyer, Herzogenaurach (DE); Klaus Wendelberger, St. Leon-Rot (DE)

(73) Assignee: SIEMENS AKTIENGESELLSCHAFT, Muenchen (DE)

(21) Appl. No.: 13/983,115

(22) PCT Filed: Feb. 3, 2012
(86) PCT No.: PCT/EP2012/051828

§ 371 Date: Oct. 22, 2013

(30) Foreign Application Priority Data
Feb. 4, 2011 (EP) 11153445.9

(51) Int. Cl. G06Q 10/06

(52) U.S. Cl. CPC G06Q 10/0631
USPC 700/97

(57) ABSTRACT

A method of producing a specific planning document for control equipment to be planned for a technical system, in particular for power plant control equipment to be planned for a power plant, and to a device designed to carry out the method are provided. A specific description of a technical system is created. Using the specific description, planning objects are selected from an archive having specified planning objects. Then the selected planning objects are adapted to the system using the specific description, wherein the specific planning document is formed from the adapted or specific planning objects.

### CROSS REFERENCE TO RELATED APPLICATIONS

This application is the US National Stage of International Application No. PCT/EP2012/051828 filed Feb. 3, 2012, and claims the benefit thereof. The International Application claims the benefits of European Patent Application No. 11153445.9 EP filed Feb. 4, 2011. All of the applications are incorporated by reference herein in their entirety.

### FIELD OF INVENTION

The invention relates to a method for producing a specific planning document for instrumentation and control equipment to be planned for a technical system, in particular for power plant instrumentation and control equipment to be planned for a power plant, and to a device designed to implement the method.

### BACKGROUND OF INVENTION

Control technology, in this case process control technology of a system, usually describes means and methods for open and closed loop control and protection of such a process or industrial system.

Planning is usually understood to be preparation for an event, a process or an actual construct. In the process engineering and process automation field, the term planning is used for the creation of technical (or other) documentation for a system to be planned.

So-called instrumentation and control functions form the subject matter of such planning documents, such as for example:
control system flowcharts for open-loop and closed-loop controls (open-loop control system flowchart, closed-loop control system flowchart) which show which measured variables are used in a system and how these are processed algorithmically to determine how the system's drives, valves, flap-valves, motors and the like are to be operated;
Operator displays via which a plant operator obtains information about the current status of a system, for example displays, and via which the plant operator can implement control actions, for instance by means of operator control elements;
Descriptions in which functionalities of the system and automation functions of the system can be explained verbally.

Such a planning document is itself in turn usually assembled from several interrelated or linked elements which in the following will be termed so-called planning objects.

For example, such a planning object can be a (function) block (with/without links, in particular connections to other blocks) of a function chart or a link itself in a function chart, a graphical element of an operator display or of an operator interface or a text block of a description.

Planning of higher-order control functions in process automation is basically very expensive and prone to errors.

Standardization is an efficient method by which the costs of planning or the creation of such planning documents can be reduced and quality improved.

Within the framework of standardization or the use of standards, it is also known to suitably file or store such standards in libraries, archives, databases and the like, for example—which is also possible in various forms such as paper or electronically—which are accessible to a user, for example a planner

Repeated use of standards in the planning or for a planning document, as for a function chart, an operator display or a description, ensures that
on the one hand the corresponding planning cost is appreciably reduced, since reference can be made to existing (standard) masters,
and on the other hand the quality of the planning is considerably improved since (standard) documents are called upon, and these have already been proven in a number of projects.

However, industrial plants differ in their specific technical processes and/or physical construction (design of plants based on different operating points and operating methods, other manufacturers for individual plant components, and the like). Moreover, customers stipulate different specific requirements for the respective plants.

This requires that
either defined standards are always to be adapted to the respective, specific requirements of a specific project, that is to say a system to be planned, or
different variants are to be created for each standard, with which at least the majority of project-specific requirements of a plant can then be directly fulfilled.

Manual adaptation of a standard to the respective project-specific requirements is always associated with considerable expense and corresponding susceptibility to errors.

In addition, the planner must have excellent technological and control system know-how in order to correctly implement project-specific changes.

On the other hand, the control of a great variety of variants is problematic when different variants are used for each standard. If a dedicated standard is produced for each possible variant which is determined by the project-specific technical design of the respective plant, plus the respective specific customer requirements, this virtually results in inflation of standards. This leads to further disadvantages such as:
During the project-specific planning, the planner has to select the correct variant from a large number of standards. This process is already associated with considerable expense and probable error.
In addition, the planner as expert must know a lot about “his” standards, that is to say he must know his way around the standards library, archive or database.
He can also make mistakes during the project-specific selection of standards.
A multitude of standards hinders continuous maintenance and updating of standards, the library, archive or database.
However, standards libraries, archives or databases which do not store the current state of knowledge, or standards which do not reflect the current state of knowledge and even have errors, or are not mutually adapted, are rejected by the planners.

### SUMMARY OF INVENTION

An object is to create a method and a device with which planning of a technical system, in particular the production of a planning document for instrumentation and control equipment of a technical system can be implemented at low cost and lower susceptibility to errors. Furthermore, another object is to improve upon the disadvantages of the prior art.

The object is achieved by the method for producing a specific planning document for instrumentation and control equipment to be planned for a technical system, in particular for power plant instrumentation and control equipment to be planned for a power plant, and to the device for producing a specific planning document for instrumentation and control equipment to be planned for a technical system, having the features as claimed in the respective independent claim.

In the method for producing a specific planning document for instrumentation and control equipment to be planned for a technical system, a specific description of a technical system is produced. Use of the specific description allows planning objects to be selected for the system from an archive having predetermined planning objects. Use of the specific description then allows the selected planning objects to be adapted to the system (specific planning objects), with the specific planning documents being created from the adapted or specific planning objects.

In this case, specific or project-specific are understood to mean that such a type of declared or described object is characteristic for the system whose instrumentation and control equipment is to be planned in the project.

The description of the system for which the instrumentation and control equipment is to be planned includes information or a plurality of data about this system. In other words, a configuration of a (defined) system is defined via the (specific) description.

Such information or description can be, for example, a requirement or a specified requirement of the system, a supplementary condition for the system, a function of the system, a technical installation of the system, a technical component of the system, designations of components of the system or similar characteristics of the technical system.

Here the production of the specific description can be generated from direct or indirect user inputs, for example by direct input of information, by the answering of yes/no questions, by multiple choice user inputs or by inputting analog numerical values.

Such generation can also be information entry, in particular automatic information entry via an interface. Generation also includes drawing on existing information, in particular information stored centrally or locally.

In this case the generated specific description of the system can be generated or can exist by the use of or in the form of an (entry) list, for example a (variant) definition list and/or a function list.

For example, the specific construction of a technical system (for example type of power plant boiler, number of generating sets and the like) and/or customer-specific requirements to be met (for example customers of the VGB market—European Association for Power Generating Utilities), can be defined via such a variant definition list.

For example, by means of a designation or identifier, the specific planning document or planning object to be produced can be unambiguously allocated to a process component of the system to be planned, such as a generating set, via such a function list.

In the invention, archive is quite generally understood to be an availability of specified information, in this case specified planning objects, in any form and/or at any location—or also locally at any location.

Such an archive can be for example a library, a database and the like, where the available information is accessible in any form, for example on paper or also electronically.

The specified planning objects for a planning document are available in such an archive for selection using the specified description.

Here a planning document can be
a function plan, in particular a closed-loop control function plan (also abbreviated to control function plan), or an open-loop control function plan of a component, for example a drive, a valve, a flap valve, a motor and the like, of a technical system,
a user interface (operator display) for a technical system, and/or
a description, in particular a textual description of a technical system, in particular a description of a functionality of a technical system.

Here, planning objects are understood to be (component) parts or elements of such planning documents.

Such a planning object can be, for example
a (function) block (with/without links, in particular connections to other blocks) and/or an object of a function plan,
a link or a linking line and a (sub) structure in a function plan and/or between (function) blocks,
a graphical element of an operator display or operator interface, or
a text block of a description.

The planning objects specified in the archive are in each case specified for a large number (“maximum variants”) of the functionalities of technical systems—for the instrumentation and control equipment to be planned This can preferably be realized so that optional (function) blocks and/or objects of a function plan, optional links and/or structures/sub-structures in a function plan, optional graphical elements of an operator display and/or optional text blocks of a description are specified.

Such a specified planning object can also be linked to a logic system, in particular to a binary logic system, and/or a rule. In particular, each specified planning object which exists or does not exist in relation to a project-specific variant, can in each case be linked to a binary logic system or rule.

Such a planning object can also have a parameter which can vary in accordance with a variant. In particular, such a variant-specific parameter can be linked to a corresponding binary or analog variable.

Furthermore, provision can be made for these logic systems, rules and/or variables to be linked to each other. Rules can also be formulated linking these logic systems, rules and/or variables to each other

In particular, the selection and/or the adaptation of the planning objects can be carried out by means of these links. This can preferably be realized in that options of optional (function) blocks and/or objects of a function plan, options of optional links and/or structures/sub-structures in a function plan, options of optional graphical elements of an operator display and/or options of optional text blocks are selected. For example, this can be realized by using switches—with an appropriate switch position.

As is obvious, this inventive archive is therefore a standards database in which for each planning document a corresponding standard is specified in a configuration (“maximum standard”, “maximum variant”) which is valid for a large number of technical systems—for which instrumentation and control equipment is to be planned That is to say the planning objects of the planning documents are available for selection and adaptation/specification in this maximum database in a maximum variant.

During the selection of the planning objects from the archive, the specific description can be initially evaluated, thereby defining which standard is required in which variant in the project.

The variant of a specific standard that is required in the project can be defined in particular via the entry list, for example via the variant definition list for the planning documents, that is to say for function plans, operator displays and descriptions. According to this definition, the planning objects required for the specific planning can then be selected from the archive.

During the adaptation of the selected planning objects, the specific description, the logic systems, in particular the binary logic systems, and/or the rules of or “behind” the planning objects can be further evaluated.

Based on this, the adaptation (specification) of the planning objects (specific planning objects) can be realized in particular by
deleting, masking-out and/or displaying structures or structural elements and/or sub-structures and/or links in function plans, operator displays or descriptions,
deleting, displaying and/or masking-out parts or (sub-) objects of function plans, operator displays or descriptions which are specifically needed or not needed,
creation of specific connections or links in function plans, operator displays or descriptions,
(re)-connection or activation of switches in function plans,
(re)-location of specific planning objects,
setting parameters to specific values.

During adaptation, for example to activate switches or to insert and mask-out objects, the logic system can in this case be constructed as logic operations on one or more rules in the specific description (for example, activate switches if rule x AND NOT rule y OR rule z=TRUE). It is equally possible for switching criteria from numerical values stated in the specific description to be derived from variables (for example rule x=2, rule y>3 and so on).

It is also conceivable to generate new structures or structural elements and/or sub-structures, new objects, which are specifically required, new connections or links, new switches or switch connections—and to include these in the specific planning document. These “new creations” could also then be entered into the archive—again in maximum variants. In other words, new variants of standards can be produced and stored in the database.

Therefore, expressed simply and clearly, with the invention of standards in which maximum variants of specific functions are filed, project-specific planning documents are automatically “assembled” by using simple (project-) specific data. These (project-) specific data can be obtained from entry lists—to be completed by the planner—and define which standard in which variant in the project is required for “assembly”.

The inventive device for producing a specific planning document has this archive with—the available—stipulated planning objects for a planning document, as well as the specific description of the technical system to be planned.

Furthermore, the device has data processing means, in particular a programmed arithmetic logic unit—also described in the following as a generator, for example—which is set up in such a way that
planning objects can be selected from the archive with the specified planning objects using the specific description, and
using the specific description, the selected planning objects can be adapted to the system to be planned (specific planning objects), with the specific planning document able to be generated from the adapted or specific planning objects.

In particular, the device is suitable for implementing the inventive method or one of its developments, which are explained below.

In many respects, the invention proves to be considerably advantageous.

Due to the automated procedure, a considerable reduction in planning costs can be achieved by the invention.

Savings in time and cost can be made, in particular, by the simplified and automatic generation of the specific description, for example by the planner answering simple questions in the planning lists.

The project-specific adaptation of the planning documents occurs automatically “at the push of a button” without the planner himself as expert having to consider details of the planning objects in the archive. In addition, the linking of the rules to the planning objects offers the possibility of creating already predefined structures.

In each case there is only one single “maximum variant” for the planning objects in the archive. The maintenance and updating of the archive or the planning objects is considerably simplified as a result.

The quality of the planning is appreciably improved since the project-specific planning documents are always generated from the same planning objects, which then have already been proven in a great many systems.

Planning objects which are not required for specific projects do not appear in the (project)-specific planning document and therefore also do not impact resources of the control system.

Finally, the specific planning document contains only the planning objects (in a specific link) which are also required in the specific project and therefore remains clear and easy to handle.

Preferred developments of the invention are also set out in the dependent claims.

The described developments refer to both the method and to the device.

The invention and the described developments can be realized in software as well as in hardware, for example by the use of a special electrical circuit.

Furthermore, a realization of the invention or of a described development is possible by means of a computer readable storage medium on which a computer program is stored, which is executed by the invention or the development.

Furthermore, it is possible to realize the invention and/or each described development by means of a computer program product having a storage medium on which a computer program is stored, which is executed by the invention or the development.

In a preferred development, a variant definition list is created in which a planner in particular enters which specific construction of a process system for which instrumentation and control equipment is to be planned—(for example power plant boiler type, number of generating sets and the like) and/or which customer-specific requirements are to be met (for example customers of the VGB market).

In a further preferred development, a function list is created in which a planner unambiguously allocates a planning object to an industrial process unit, for example by means of an identifier. For example a function plan for a closed-loop control actuator can be unambiguously allocated to a specific valve of the system by means of an identifier; or a required measured value is unambiguously allocated to a specific measuring point.

Furthermore, provision can preferably be made for the input of the variant definition list and/or function list to be realized by answering yes/no questions and/or inputting analog numerical values (for example by interrogating the number of generating sets).

Furthermore, provision can preferably be made for the variant definition list and/or the function list to be read in by means of the data processing means.

In a further preferred development, provision can be made for the specific description, in particular the entry list or the entry lists, to be evaluated using rules, by which the planning objects to be selected can be determined (selection of the required standard or required standard variant) and/or the adaptation of the selected planning objects (specification) to the system to be planned can be implemented.

In a preferred development provision is made for the production of the specific planning document to be connected to or extended by an identification system.

Here, in each case, a designation or dummy identification mark or dummy identifier can be specified for objects provided during planning, for example for measurements, drives, measuring transducers, logic systems, valves, switches, and the like, in particular for all input and/or output variables of the planning objects.

During the selection and/or the adaptation, the dummy identifiers of the selected objects can then be determined and replaced by their specific identifiers—if specified or if any exist, for example from the specific description.

This can be simply realized so that a list (identifier list) is generated with all dummy identifiers used for or during the specific planning and—where specified—these are replaced at that point by specific identifiers.

This has the advantage that a specific identification has to occur only once and with the replacement of the dummy identifier which generally occurs a number of times in the specific planning document, this is then automatically reproduced with the specific identifier in the specific planning documents and “reported” there.

If—unspecified—dummy identifiers still occur in the specific planning document or the local objects, these can also be “updated” by subsequent single input by the user—and reproduce themselves automatically as described, via their replacement in the planning document or generate a check-back signal there.

Furthermore, provision is preferably made for the generated project planning document for the instrumentation and control equipment of the system to be planned, in particular for the power plant instrumentation and control equipment of the power plant to be planned, to be installed or used and/or for the system, in particular the power plant, to be controlled, regulated and/or monitored using the generated specific planning document.

In addition to this, the specific planning document in particular can be implemented or installed on a power plant master computer to carry out the open-loop and closed-loop control and/or monitoring of the system or of the power plant.

### BRIEF DESCRIPTION OF THE DRAWINGS

An exemplary embodiment of the invention is illustrated in the figures, which are explained in detail later on. Here

FIG. 1 shows an overview of a system for automated production of planning documents for instrumentation and control equipment for a power plant (ART-E),

FIG. 2 shows ART-E with adaptation of a function plan,

FIG. 3 shows adaptation of a function plan,

FIG. 4 shows adaptation of a function plan

FIG. 5 shows an overview of method steps in the system for automatic generation of planning documents for instrumentation and control equipment for a power plant (ART-E),

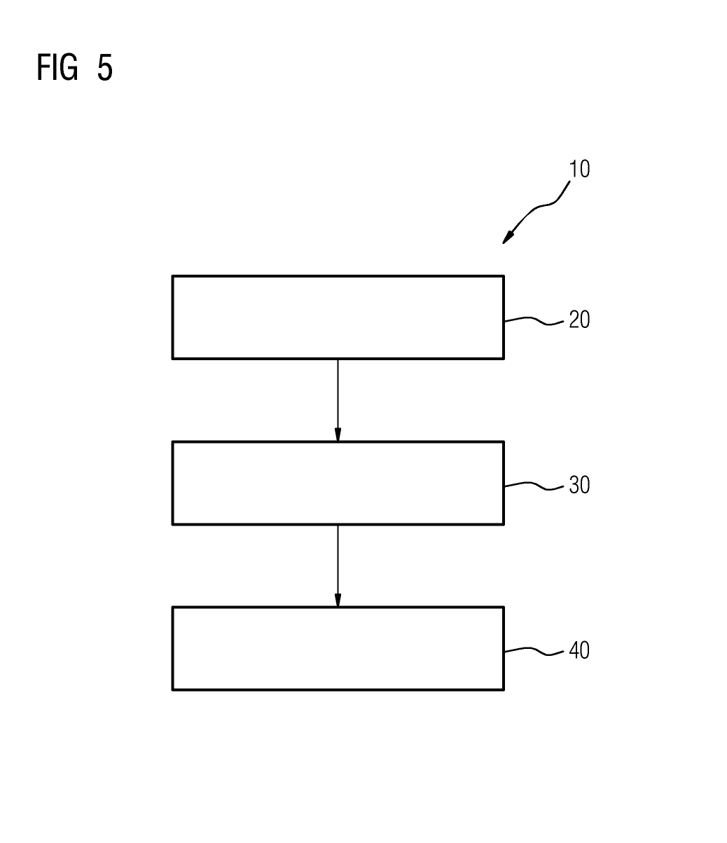

FIG. 6 shows a (variant)-definition list, VDef, and

FIG. 7 shows a function list FL.

### DETAILED DESCRIPTION OF INVENTION

Exemplary embodiment: system for automatic production of planning documents by means of maximum standards (Advanced Rapid Technology Engineering [ART-E]) (1).

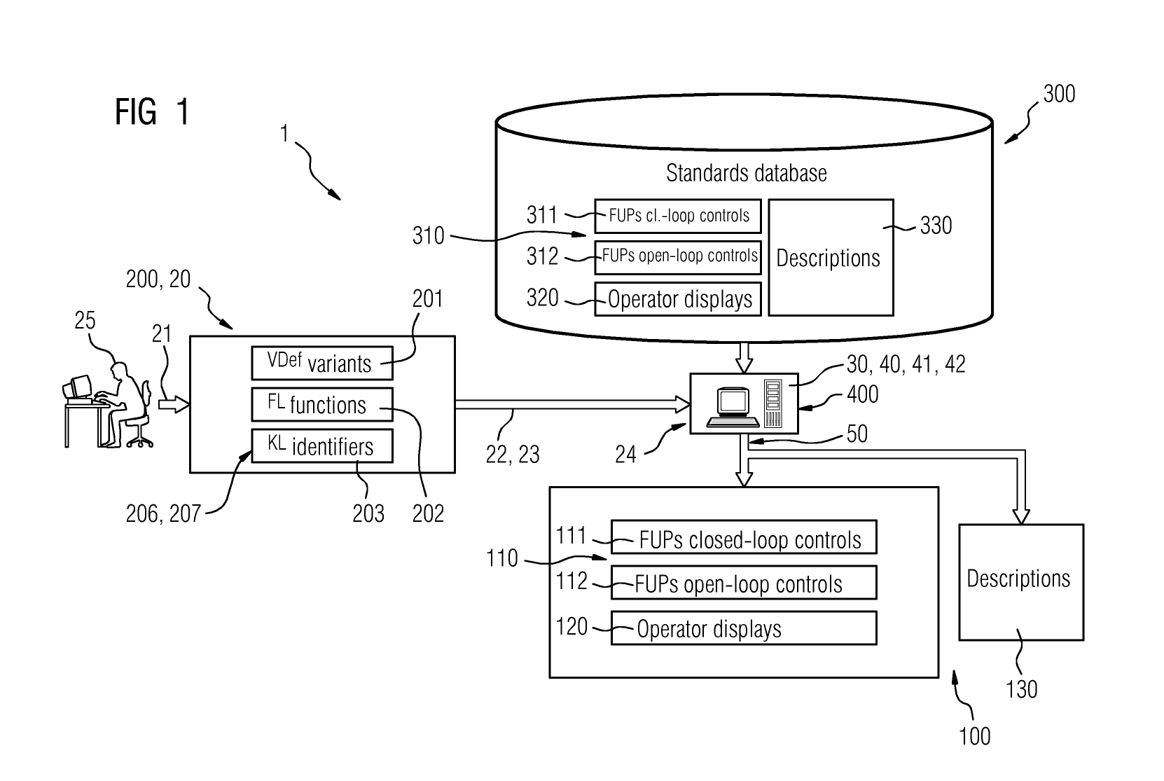

FIG. 1 shows an overview of a system 1—with its main component parts, functions and (functional) connections—for automatic production of planning documents for instrumentation and control equipment for a power plant.

This (planning) system 1, abbreviated in the following as ART-E (Advanced Rapid Technology Engineering), has the following—initially in a clear representation—described structure or functionally:

ART-E includes a standards database 300 in which an appropriate standard 310, 320, 330, 311, 312 is stored for each planning document (function plan 310, operator display 320, description 330).

Here each standard 310, 320, 330, 311, 312 is constructed as a maximum variant, that is to say all possible functions which could be required in various (planning) projects, are included in this one standard.

Each planning document or each standard 310, 320, 330, 311, 312 consists of planning objects, which are for example blocks and/or connecting lines in the function plans 310, 311, 312, graphical elements in operator displays 320 or text blocks in descriptions 330.

Each planning object of a standard 310, 320, 330, 311, 312, which exists or does not exist in relation to a project-specific variant, is linked by a corresponding binary logic system.

Each parameter of a planning object or of a standard which has to change depending on a project-specific variant, is linked to a corresponding binary or analog variable.

Variant definition lists 201 are created in which a planner 25 can specify which specific construction of a process system (for example power plant boiler type, number of generating sets and so on) is available and which customer-specific requirements are to be fulfilled (for example a customer of the VGB market); (method step 20 in FIG. 1).

The input into the variant definition lists 201 is realized by answering yes/no questions or entering analog numerical values (for example by interrogating the number of generating sets); (step 21 in FIG. 1).

Function lists 202 are created in which a planner can unambiguously allocate the planning documents to be created to a process unit (for example the function plan to be created for a servo drive is unambiguously allocated via an identifier to a specific valve of the system; a required measured value is unambiguously allocated to a specific measuring point, and so on) 20.

A generator 400 automatically carries out the following tasks:
reading the data in the variant definition list 22,
reading the data in the function list 23,
corresponding evaluation of the binary logic systems for the planning objects of the planning documents 24,
creation of the project-specific planning document 100, 110, 120, 130, 111, 112 from the standard, taking account of the binary logic systems affecting the individual planning objects (for example deleting the objects which are not required for the specific project and correct connection and placement of the remaining objects) 41,
adapting parameters in the planning document according to the data in the variant definition list 42,
outputting the project-specific planning document created in this way, taking account of the data in the function list 50.

The individual elements of ART-E are described in further detail below.

Standards Database 300

Standards, 310, 320, 330 for the function plans 311, 312 (closed-loop and open-loop controls) as well as for operator displays 320 and descriptions 330 are stored in the standards database (standards database).

Here each standard document is a maximum variant of this function. In the real project, only one part of this maximum variant is used (adaptation, specification)—for example by disconnecting optional sub-structures.

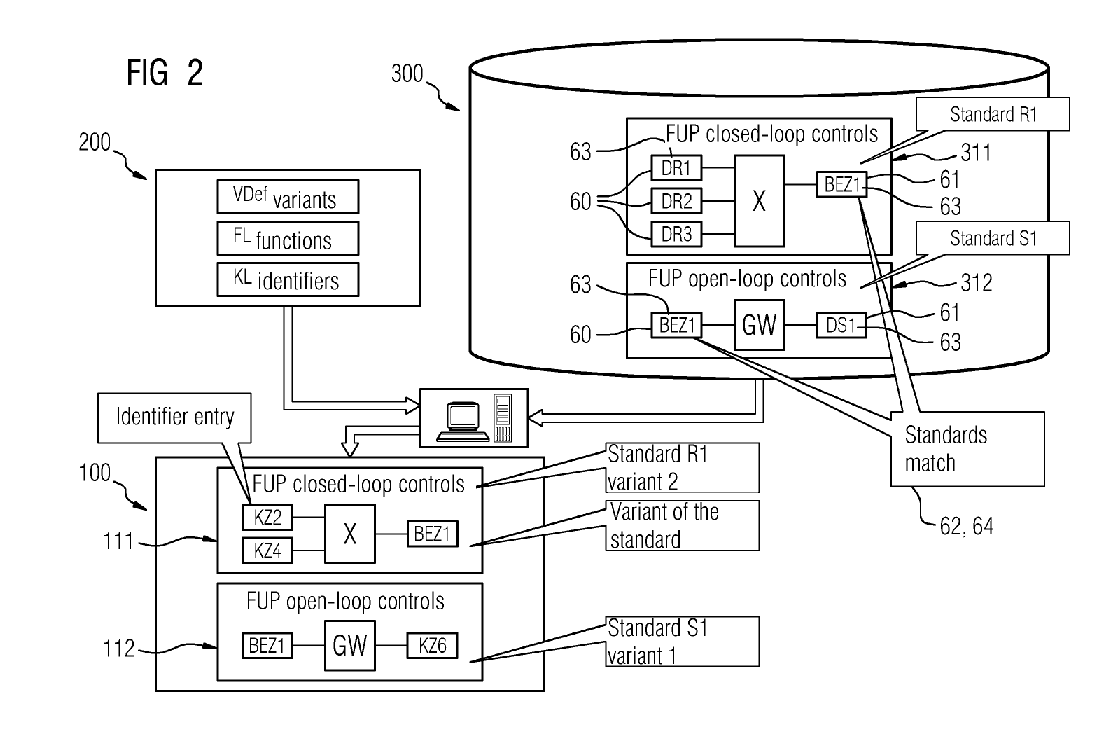

Input/output signals 60, 61 in the standards 310, 320, 330 are given dummy identifiers 63. However, at the same time, the individual standards are defined in such a way that they represent a self-contained system 62 (FIG. 2).

The connections to be made between the standards are already included in the standards database 64, required signals from the measurement data acquisition or check-back signals of the drives are generated automatically; if necessary, the function plan is structurally adapted (FIG. 2).

The optional sub-structures 71 are defined in the standard 310 by using analog and binary switches 72. Consequently, it is possible for all functions contained in a standard to be shown in one overview display.

The cases where a switch 72 is set to either one or the other position 73 can be clearly stated in a description of the standards 310.

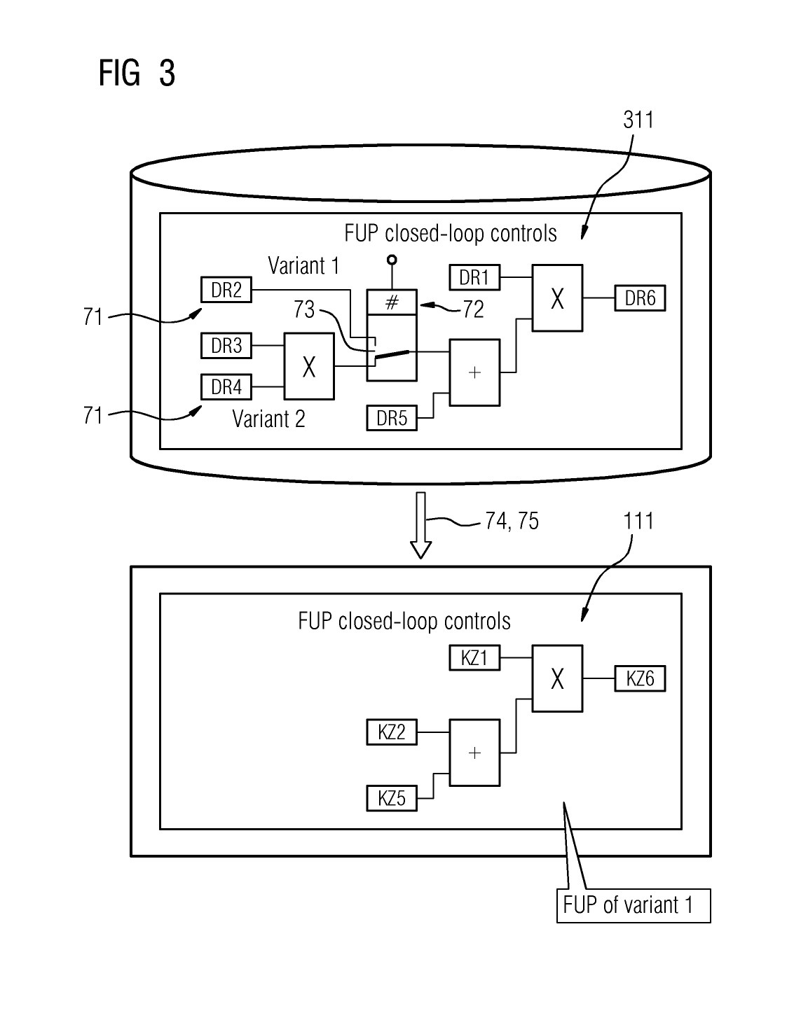

In the generation of the project-specific function plan 110, 111, 112, the unwanted sub-structure 71, including the switch 72 itself is deleted automatically 74 and the connections which are broken as a result are reclosed 75 (FIG. 3).

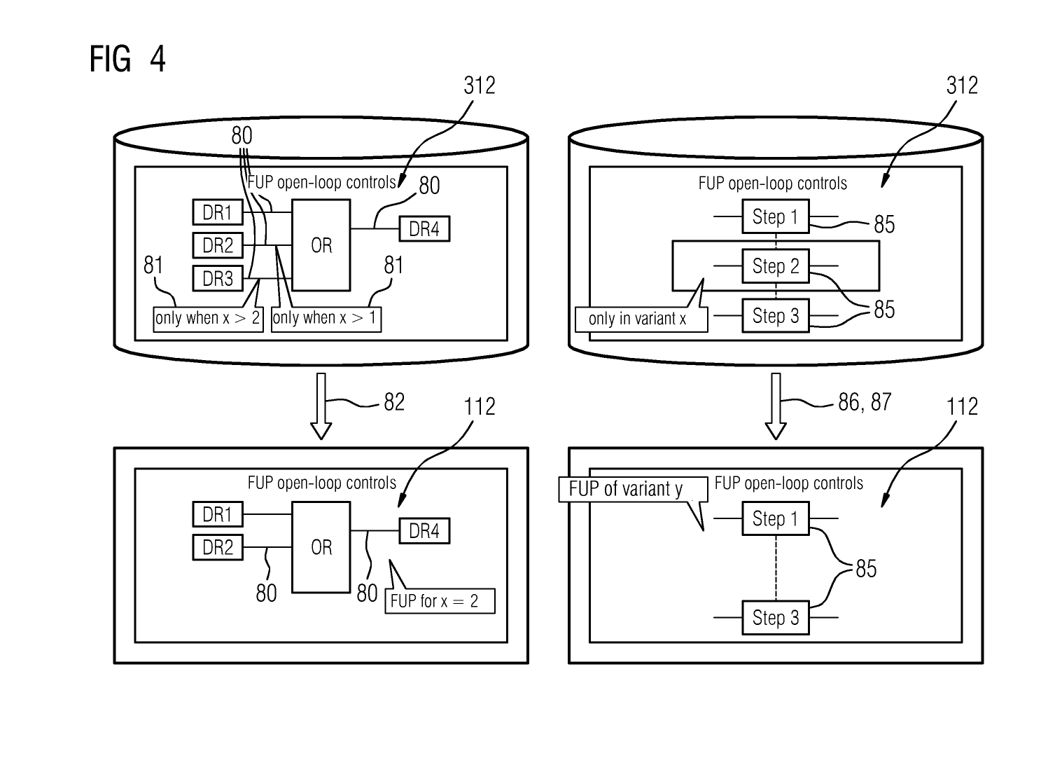

In parallel with this, it is also possible to define linking lines 80 as a specific variant also to be defined 81. If the corresponding variant is not selected, the connecting line 81 is automatically deleted 82 (FIG. 4).

A block 85 is automatically deleted 86 even without a switch 72 being present and the broken connection is reclosed 87 if it is not required in the selected variant (FIG. 4).

In an equivalent manner in the operator displays 320 the graphical elements and the individual text sections of a variant in the descriptions 330 are allocated and automatically deleted if the corresponding variant is not selected.

The required standards are created as described for the technical sub-systems of the plant.

Appropriate to these standards, entry lists 90 must be provided and define which variants of standards are required in the relevant project.

The construction of the entry lists 90 is described as follows.

Entry Lists 90

Which variant of the standard required in the project is defined by means of entry lists 90 (specific description (200) to be filled out by the planner 25).

(Variant) Definition List VDef 201

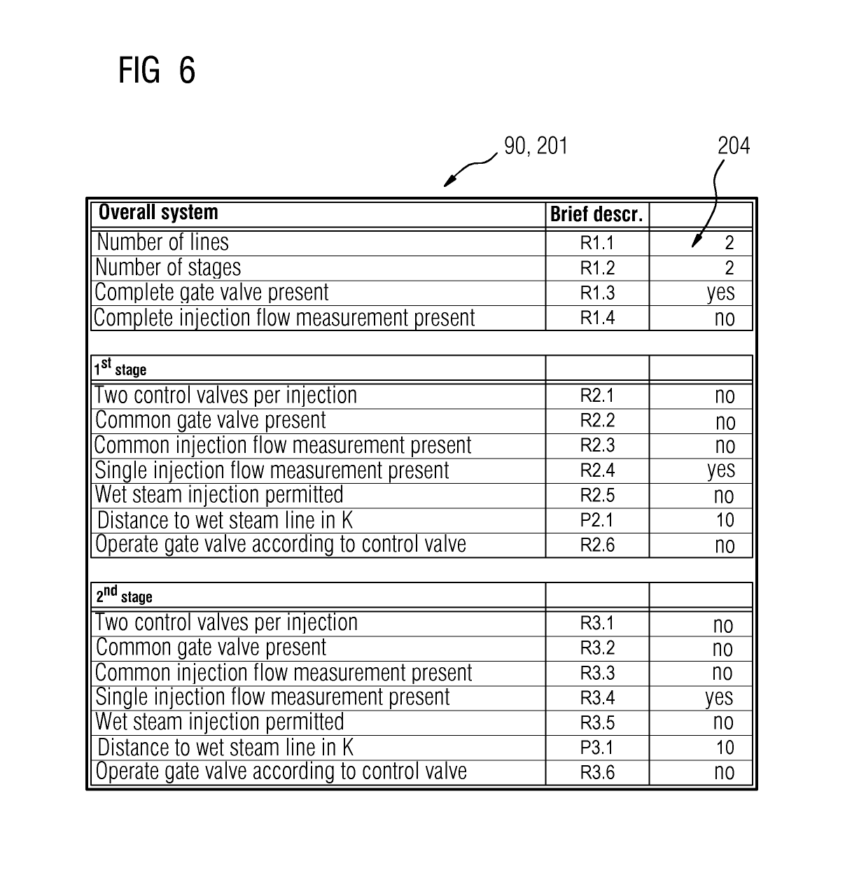

Which variant of a specific standard required in the project (FIG. 6) is stipulated in the VDef 201 for the function plans of the closed-loop and open-loop controls, operator displays and the descriptions.

The details in the VDef 201 result in the following
in the function plans the switches 72 defined in the standards are actuated or not actuated 73 (see FIG. 3),
in the function plans the connecting lines 80 and blocks 85 which are allocated to a specific variant, are either shown or not shown 82, 86, 87 (see FIG. 4),
specific sub-structures are shown or not shown 74, 75 in the operator displays (see FIG. 3)
specific partial descriptions are outputted Or not outputted.

Here the logic system for engaging the switches 72 or for showing and masking-out objects 86 can be constructed in the VDef as logic operations conforming to one or more rules, for example actuating switches, if R1.3 AND NOT R2.2 OR R2.4=TRUE.

It is equally possible for switching criteria to be derived from numerical values 204 indicated in the VDef, for example R1.1=2, R1.2>3, and so on.

In addition, data are contained in the VDef 201 which cause parameters in the function plans to be set to the indicated values, for example P2.1=10.

Function List, FL 202

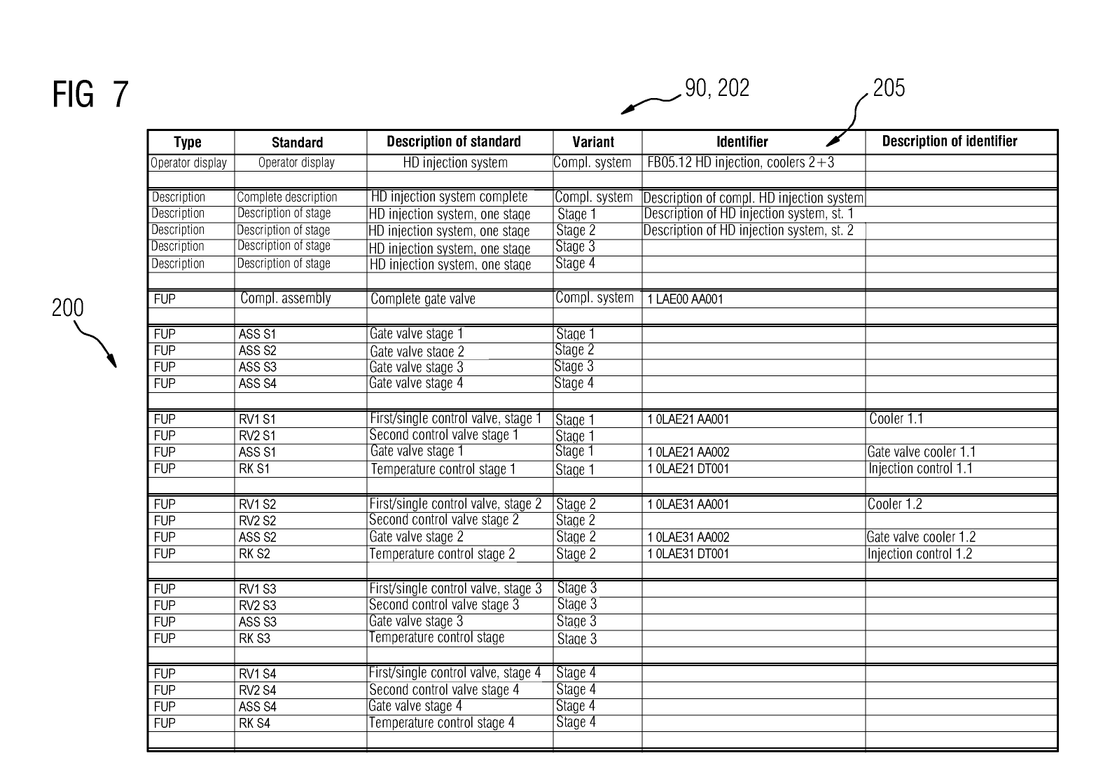

The allocation of the identifiers 205 for operator displays, descriptions, control circuits, controllers to the standards or to the variants indicated in the VDef 201 (sets of rules) is specified in the FL 202 (FIG. 7).

The required standard is specified for each identifier 205 (operator display, description, open-loop actuator, closed-loop actuator). Just one standard is allocated to each identifier 205 and vice versa. In addition, reference is made to a variant (set of rules) stated in the VDef 201 in order to specify the required realization of this standard.

Identifier List, KL 203

Following generation or after adaptation/specification 40, the function plan 110, the operator displays 120 and the descriptions 130, which were created from a standard in a specific variant, still have open connections.

All dummy identifiers 63, which act on this standard “from outside” (measuring signals, signals from other standards) have not yet been defined.

In addition, the following conditions apply:
All connections which were included in the standards database 300 are likewise included in the project or in the specific planning document 110, 120, 130, as soon as the source and destination plan has been generated.
Insofar as they are already known via the entries in the FL 202—the dummy identifiers 63 are replaced by the project-specific identifiers 205.
The user/planner 25 has the option to display 206 all open connections of the function plans 110, operator displays 120 and descriptions 130. Here, connections to measurements appear as open. In this case, each open signal is routed only once into the KL 203.
The user can enter 207 the missing identifiers 205 into the KL 203.

Automatic Generation, Adaptation/Specification 40

Building on the existing data in the entry list 90, the system 1 for the automatic generation of (specific) planning documents 100 is able to automatically generate the function plans (individual plans, area/overview plans, fail-safe area plans) 110 and operator displays 120, as well as the descriptions 130.

The generator 400
determines the required standards 30 from the data in the VDef 201 and FL 202,
selects, 30, the correct standards 310, 320, 330 from the standards database 300,
automatically adapts the standards (generation of project-specific variants) 40 and in so doing creates the specific planning document 100, that is to say the specific function plans 110, operator displays 120 and descriptions 130, 40,
generates the KL 203,
replaces the dummy identifiers 63 by project-specific identifiers 205.

In this case the generator 400 is of a general construction so that the planner of the standards and entry lists 310, 320, 330, 90, can make changes to the standards 310, 320, 330, without the need for software-based adaptation of the generator 400.

In particular, the standards planner/designer has the option
to change the internal structure of the standards 310, 320, 330,
to produce new variants of standards 310, 320, 330, that is to say to incorporate in the standards 310, 320, 330, additional switches 72 or objects 85 which are allocated to specific variants, and to specify additional criteria by extending the VDef 201, with which these switches 72 are actuated or the objects are shown or masked-out,
to extend the VDef 201 by additional variants (sets of rules),
to enable the logic for resetting the variants to the position of the switches 72 or to change the display or masking-out of objects 85 (for example previously a switch is actuated in accordance with rule A and subsequently in accordance with rule A&B),
to define additional standards 310, 320, 330 and to extend the FL 202 accordingly,
to use additional input signals 60 in the standards 310, 320, 330 or to delete previously used input signals 60.

### LIST OF REFERENCE NUMBERS

1 (Planning) system, Advanced Rapid Technology Engineering (ART-E)
10 Method steps
20 Generation of specific description
21 User input
22 Read-in (variant) definition list
23 Read-in function list
24 Evaluation of logic systems or binary logic systems
25 Planner
30 Selection of planning objects
40 Adaptation
41 Creation of project-specific planning documents
42 Adaptation of parameters
50 Outputting of project-specific planning documents
60 Input signal
61 Output signal
62 Closed system
63 Identifiers, dummy identifiers
64 Closing of connections, closed connections
71 Optional sub-structure
72 Switches, analog switches, binary switches
73 Switch position
74 Deletion of a sub-structure
75 Closing of connections
80 Connection, connecting line
81 Allocation of a connecting line to a standard
82 (Automatic) selection of a connecting line
85 Block, object
86 Deletion of a block
87 Closing of a connecting line
90 Entry list
100 Specific planning document
110 (Specific) function plan
111 (Specific) function plan—closed-loop control
112 (Specific) function plan—open-loop control
120 (Specific) operator display
130 (Specific) description
200 Specific description of the system
201 (Variant) definition list
202 Function list
203 Identifier list
204 Numerical value
205 Identifier, project-specific identifier
206 Check-back signal, display of identifiers not yet specified
207 Entry of specific identifiers in an identifier list
300 Archive, maximum database
310 (Specified) function plan
311 (Specified) function plan—closed-loop control
312 (Specified) function plan—open-loop control
320 (Specified) operator display
330 (Specified) description
400 Generator, arithmetic logic unit, data processing means.

1.-8. (canceled)

9. A method for producing a specific process control planning document for instrumentation and control equipment to be planned for a specific technical system, in particular for power plant instrumentation and control equipment to be planned for a power plant, using an archive with selectable, process control standard planning documents (standards) from interlinked, adaptable, process control planning objects, wherein, in each case, the process control standard planning documents which are selectable from the archive are specified as maximum variants in an embodiment which is valid for a large number of technical systems, the method comprising:
generating a specific description of a specific, technical system,
evaluating the specific description, determining a variant of a standard planning document (standard) which is required for the specific, technical system, and selecting a process control standard planning document required for the specific, technical system from the archive,
generating a specific, process control planning document from the selected process control standard planning document:
by automatically adapting the interlinked, adaptable, process control planning objects of the selected, process control standard planning document using the specific description to the specific technical system,
wherein at least deletions, disconnections and/or masking-out of the interlinked, adaptable, process control planning objects of the selected, process control standard planning document are implemented during the adapting.

10. The method for producing a specific process control planning document as claimed in claim 9, wherein the specific description describes a configuration of the specific, technical system using an entry list.

11. The method for producing a specific process control planning document as claimed in claim 9, wherein the process control planning document is a closed-loop control function plan or an open-loop control function plan, an operator display and/or a description of a technical system.

12. The method for producing a specific process control planning document as claimed in claim 9, wherein an adaptable, process control planning object is a (function) block and/or an object of a function plan, a link and/or a (sub)-structure in a function plan, a graphical element of an operator display and/or a text block of a description.

13. The method for producing a specific process control planning document as claimed in claim 9, wherein the specific description, in particular an entry list, is evaluated using rules, whereby the interlinked, adaptable, process control planning objects of the selected, process control standard planning document are adapted to the specific, technical system.

14. The method for producing a specific process control planning document as claimed in claim 9, wherein the adapting of the interlinked, adaptable, process control planning objects of the selected, process control standard planning document is achieved
by deleting, masking-out and/or displaying of structures and/or sub-structures and/or connections in function plans, operator displays or descriptions,
by deleting, displaying and/or masking-out of (partial) objects of function plans, operator displays or descriptions,
by creating specific connections in function plans, operator displays or descriptions,
by (re)-connecting or actuating switches in function plans,
by (re)-positioning specific, process control planning objects and/or
by setting parameters to specific values.

15. A device for producing a specific process control planning document for instrumentation and control equipment to be planned for a specific, technical system, in particular for power plant instrumentation and control equipment to be planned for a power plant, comprising:
a specific description of a specific, technical system,
an archive with selectable, process control standard planning documents (standards) from interlinked, adaptable, process control planning objects, wherein, in each case, the process control standard planning documents which are selectable from the archive, are specified as maximum variants in an embodiment which is valid for a large number of technical systems,
a programmed arithmetic logic unit which is configured for implementing a method of producing a specific, process control planning document for instrumentation and control equipment to be planned for a specific technical system, in particular for power plant instrumentation and control equipment to be planned for a power plant, using an archive with selectable, process control standard planning documents (standards) from interlinked, adaptable, process control planning objects, wherein, in each case, the process control standard planning documents which are selectable from the archive are specified as maximum variants in an embodiment which is valid for a large number of technical systems, the method comprising:
generating a specific description of a specific, technical system,
evaluating the specific description, determining a variant of a standard planning document (standard) which is required for the specific, technical system, and selecting a process control standard planning document required for the specific, technical system from the archive,
generating a specific, process control planning document from the selected process control standard planning document:
by automatically adapting the interlinked, adaptable, process control planning objects of the selected, process control standard planning document using the specific description to the specific technical system,
wherein at least deletions, disconnections and/or masking-out of the interlinked, adaptable, process control planning objects of the selected, process control standard planning document are implemented during the adapting.
